(19) United States
(12) Patent Application Publication
(10) Pub. No.: US 2013/0335421 A1
(43) Pub. Date: Dec. 19, 2013

(54) METHOD FOR GENERATING A GRAPHICAL REPRESENTATION OF STRUCTURED DATA, GENERATION APPARATUSES AND COMPUTER PROGRAM PRODUCT

(71) Applicants: Marquart Franz, Sauerlach (DE); Asa MacWilliams, Furstenfeldbruck (DE)

(72) Inventors: Marquart Franz, Sauerlach (DE); Asa MacWilliams, Furstenfeldbruck (DE)

(21) Appl. No.: 13/524,349

(22) Filed: Jun. 15, 2012

(51) Int. Cl. G06T 11/20

(52) U.S. Cl. 345/440

(57) ABSTRACT

A method for generating a graphical representation of structured data may include: identifying interaction markers in data elements of the structured data, wherein each interaction marker identifies an interaction interface of the respective data element, analyzing at least one predetermined attribute of the identified interaction markers, selecting a symbolic representation for each of the identified interaction markers based on the respective at least one analyzed predetermined attribute, generating the graphical representation of the structured data using the respective selected symbolic representations for all identified interaction marker. Generation apparatuses for generating a graphical representation of structured data and a computer program product are also disclosed.

### TECHNICAL FIELD

The disclosure relates to a method for generating a graphical representation of structured data. Furthermore, the disclosure relates to generation apparatuses for generating a graphical representation of structured data and a respective computer program product.

### BACKGROUND

Although applicable to any system that is concerned with displaying structured data, the present disclosure will be described in combination with UML-Diagrams.

In the development process of complex software systems component diagrams of a graphical notation, e.g. UML (Unified Modelling Language), are commonly used to document a software system or to display the structure of a complex software system.

Such complex software systems usually comprise a variety of different interfaces that define interaction capabilities between different objects, e.g. classes, of said complex software system. Interfaces are commonly illustrated according to the so called “ball socket notation”, wherein the ball is connected to the class which provides or implements an interface and the socket is connected to the class that uses an interface.

In complex diagrams an arrow, usually drawn in dashed style, connects the ball and the socket.

Just displaying two classes connected by an arrow according to the ball socket notation does not disclose the type of interface that is used for interactions between said two classes. Therefore the name of the interface is usually written near the ball and the corresponding socket. FIGS. 1 and 2 show such conventional class diagrams.

In FIG. 1 a class diagram with three classes C-1, C-2 and C-3 is illustrated. Class C-1 implements two interfaces I-1 and I-3. Class C-2 has an interface 1-2 and Class C-3 has an interface I-4. In FIG. 1 the interfaces I-1 and I-3 are illustrated as circles connected to class C-1. Furthermore interfaces I-2 and I-4 are illustrated as half circles with the same radius as the circles used for interfaces I-1 and I-3. Finally an arrow drawn in a dashed line from interface I-2 to interface I-1 and from interface I-4 to interface I-3, respectively, is used to illustrate that class C-2 accesses the interface I-1 of class C-1 and class C-3 accesses the interface I-3 of class C-1.

Furthermore, the name of the respective interface is printed next to every single interface I-1, I-2, I-3 and I-4. With only three classes C-1, C-2 and C-3 and four interfaces I-1, I-2, I-3 and I-4 this class diagram is already cluttered with information and hard to read.

In FIG. 2 another class diagram is illustrated. In the class diagram in FIG. 2 only one class C-4 and one interface I-5 are identified by reference signs although FIG. 2 shows a variety of nine classes and over thirty interfaces. Furthermore, the name of every interface is printed next to every interface. In FIG. 2 it becomes clear that complex class diagrams are very difficult to read and will be crowded with interface names.

Accordingly, there is a need for improved display of structured data.

### SUMMARY

In one embodiment, a method for generating a graphical representation of structured data comprises identifying interaction markers in data elements of the structured data, wherein each interaction marker identifies an interaction interface of the respective data element, analyzing at least one predetermined attribute of the identified interaction markers, selecting a symbolic representation for each of the identified interaction markers based on the respective at least one analyzed predetermined attribute, generating the graphical representation of the structured data using the respective selected symbolic representations for all identified interaction markers.

In another embodiment, a generation apparatus for generating a graphical representation of structured data comprises an identification unit configured to identify interaction markers in data elements of the structured data, wherein each interaction marker identifies an interaction interface of the respective data element, an analyzing unit configured to analyze at least one predetermined attribute of the identified interaction markers, a selection unit configured to select a symbolic representation for each of the identified interaction markers based on the respective at least one analyzed predetermined attribute, and a generation unit configured to generate the graphical representation of the structured data using the respective selected symbolic representations for all identified interaction markers.

In another embodiment, a generation apparatus for generating a graphical representation of structured data comprises a computation unit comprising a program memory, the program memory comprising computer readable instructions which cause the computation unit to identify interaction markers in data elements of the structured data, wherein each interaction marker identifies an interaction interface of the respective data element, analyze at least one predetermined attribute of the identified interaction markers, select a symbolic representation for each of the identified interaction markers based on the respective at least one analyzed predetermined attribute, and generate the graphical representation of the structured data using the respective selected symbolic representations for all identified interaction markers.

In another embodiment, a computer program product for generating a graphical representation of structured data is provided, the computer program product comprising computer readable instructions for identifying interaction markers in data elements of the structured data, wherein each interaction marker identifies an interaction interface of the respective data element, analyzing at least one predetermined attribute of the identified interaction markers, selecting a symbolic representation for each of the identified interaction markers based on the respective at least one analyzed predetermined attribute, and generating the graphical representation of the structured data using the respective selected symbolic representations for all identified interaction markers.

Certain embodiments are based on the discovery that generating a graphical representation of structured data comprising textual names of certain elements in said graphical representation will render said graphical representation less precise and less understandable.

Therefore, certain embodiments use this discovery to provide a method for generating a graphical representation of structured data that provides clear and easily understandable graphical representations of said structured data.

Furthermore, certain embodiments provide an improved information density in graphical representations of structured data. Therefore, more information can be included in a given space or with a given resolution or the same amount of information can be displayed in less space.

To achieve this, interaction markers may be identified which denote possible interactions between two elements of the structured data.

Some embodiments include analyzing attributes of the identified interaction markers for selecting a symbolic representation for each interaction marker.

In some embodiments, a graphical representation of the structured data may be generated using the selected symbolic representation.

Therefore, the plurality of different interfaces can be distinguished by the symbolic representations and interacting interaction markers of different data elements can be identified by the same or at least by similar or related symbolic representations.

Therefore, a complex graphical representation comprising various elements which comprise various interaction markers which is generated using the method according to the present disclosure will be easily understandable when viewed by a user.

In one embodiment, analyzing at least one predetermined attribute comprises statically analyzing the structured data and/or analyzing a documentation of the structured data and/or analyzing at runtime a computer program which is constructed based on the structured data. This allows selecting a graphical representation for each interaction marker based on the specific details of every interaction marker and further information provided about the interaction markers in the documentation of the structured data. Such information might for example include the author of the structured data or the like.

In another embodiment, the structured data comprises a description of a UML data structure. This allows providing a graphical representation for a general and standardized representation of structured data.

In another embodiment, the structured data comprises at least one description of a UML class diagram in XML format. This allows providing an improved graphical representation of a complex software system and especially of the interactions between the different classes of said complex software system.

In another embodiment, the interaction markers comprise interface definitions of interfaces in the description of the UML class diagram, wherein the interfaces define at least one function which is implemented by at least one class of the UML class diagram. This also allows providing an improved graphical representation of a complex software system and especially of the interfaces used for interactions between the different classes of said complex software system.

In another embodiment, analyzing at least one predetermined attribute of the identified interaction markers comprises analyzing a name and/or a position in an inheritance hierarchy and/or a number of methods and/or annotations and/or public status or private status and/or number of implementations and/or number of uses and/or role in a design pattern of the respective interface. By using predetermined attributes for the selection of the graphical representation it is possible to select specific graphical representations based on said attributes and, thus, select similar graphical representations for interaction markers that have similar values for the specific attributes.

In another embodiment, selecting a symbolic representation for each of the interaction markers comprises selecting a symbolic representation comprising a plug-like symbolic representation for an interaction marker which is associated with a class that implements at least one interface. This allows selecting one of a variety of symbolic representations and at the same time clearly showing that one class implements a specific interface.

In another embodiment, selecting a symbolic representation for each of the interaction markers comprises selecting a symbolic representation comprising a socket-like symbol for an interaction marker which is associated with a class that uses functions provided by at least one interface. This allows selecting a graphical representation for a class using or depending on an interface which must be implemented by another class.

In another embodiment, selecting a symbolic representation for each of the interaction markers comprises selecting a stored symbolic representation comprising symbols having a natural order and/or symbols having no natural order and/or a regular polygon and/or a star with at least three spikes. This allows providing additional information with a graphical representation. For example a symbol having a natural order, e.g. a star-like symbol, could have as many spikes as the interface which is represented by said star-like symbol has functions. On the other side an interface having only one function or an interface solving special tasks could be represented with a symbol having no natural order, e.g. a circle or the like.

In another embodiment, selecting a symbolic representation for each of the interaction markers comprises selecting a stored symbolic representation comprising symbols having round corners and/or indented sides and/or outdented sides and/or symbols having a specific horizontal orientation and/or symbols having a specific color and/or symbols having a specific size and/or aspect ratio and/or shading and/or outline width and/or symbols having a specific animation when displayed on screen. This allows further augmenting the information density of a graphical representation of an interaction marker. For example the specific embodiment of a graphical representation could depend on the functional area of an interface. In one embodiment for example indented sides of a symbol could signalize an interface having administrative character. In other embodiments all of the above mentioned attributes can be combined in a graphical representation to signalize different attributes of an interaction marker.

In another embodiment, selecting a symbolic representation for each of the interaction markers comprises selecting a stored symbolic representation comprising symbols representative of letters and/or numbers. Interaction makers which are represented by letters and/or numbers further improve the information density of a graphical representation. For example a letter could be selected according to the first letter of an interaction marker's name.

In another embodiment, selecting a symbolic representation for each of the interaction markers comprises selecting a stored symbolic representation comprising pictograms. Using pictograms allows further augmenting the information density of a graphical representation. In one embodiment the selected pictogram could for example correlate with the function of an interaction marker.

### BRIEF DESCRIPTION OF THE DRAWINGS

Example embodiments will be explained in more detail below with reference to figures, in which:

FIG. 1 shows a common UML class diagram;

FIG. 2 shows a common UML class diagram;

FIG. 3 shows a flow diagram of an embodiment of a method according to one embodiment;

FIG. 4 shows a block diagram of an embodiment of a generation apparatus according to one embodiment;

FIG. 5 shows another block diagram of an embodiment of a generation apparatus according to one embodiment;

FIG. 6 shows an embodiment of a class diagram according to one embodiment; and

FIG. 7 shows an embodiment of different graphical representations according to one embodiment.

The drawings illustrate example embodiments of the present disclosure. Other embodiments and/or advantages thereof may be readily appreciated in view of the following detailed description. The elements of the drawings are not necessarily drawn to scale relative to each other. Like reference numerals designate corresponding similar parts.

### DETAILED DESCRIPTION

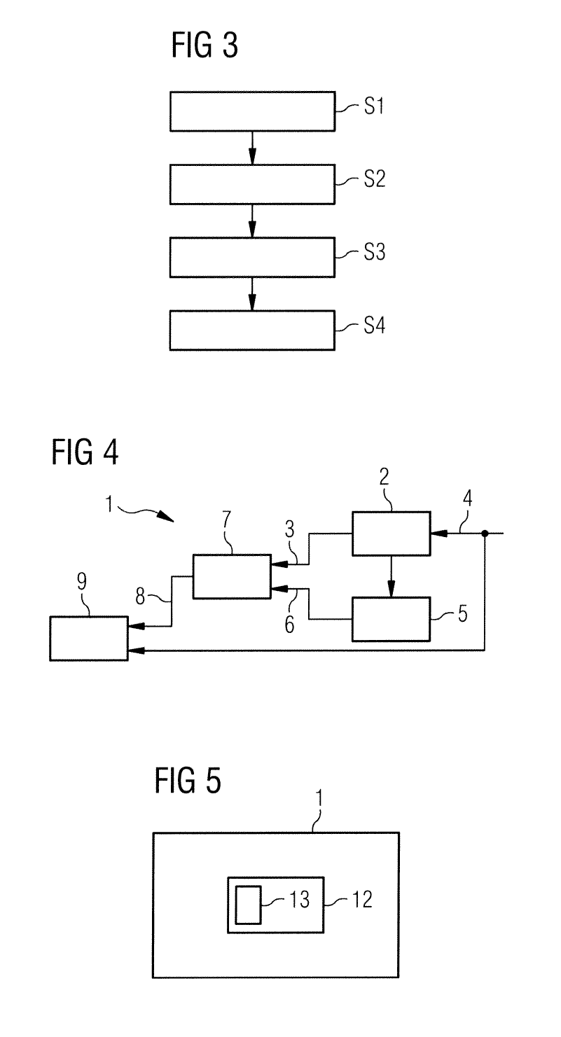

FIG. 3 shows a flow diagram of an embodiment of a method according to an example embodiment.

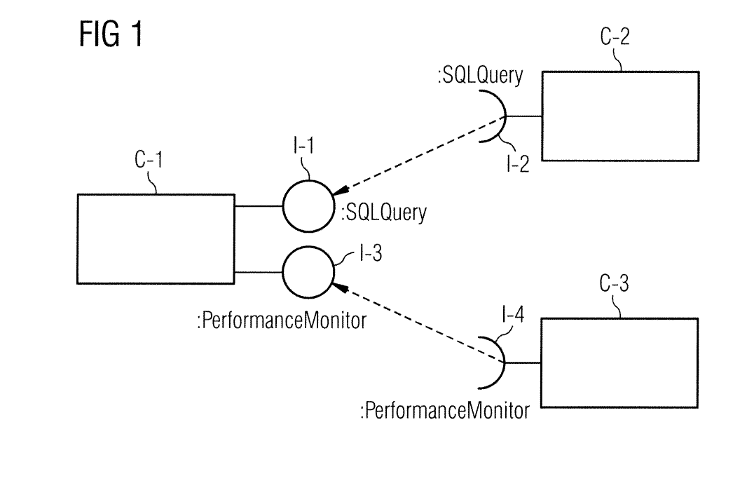

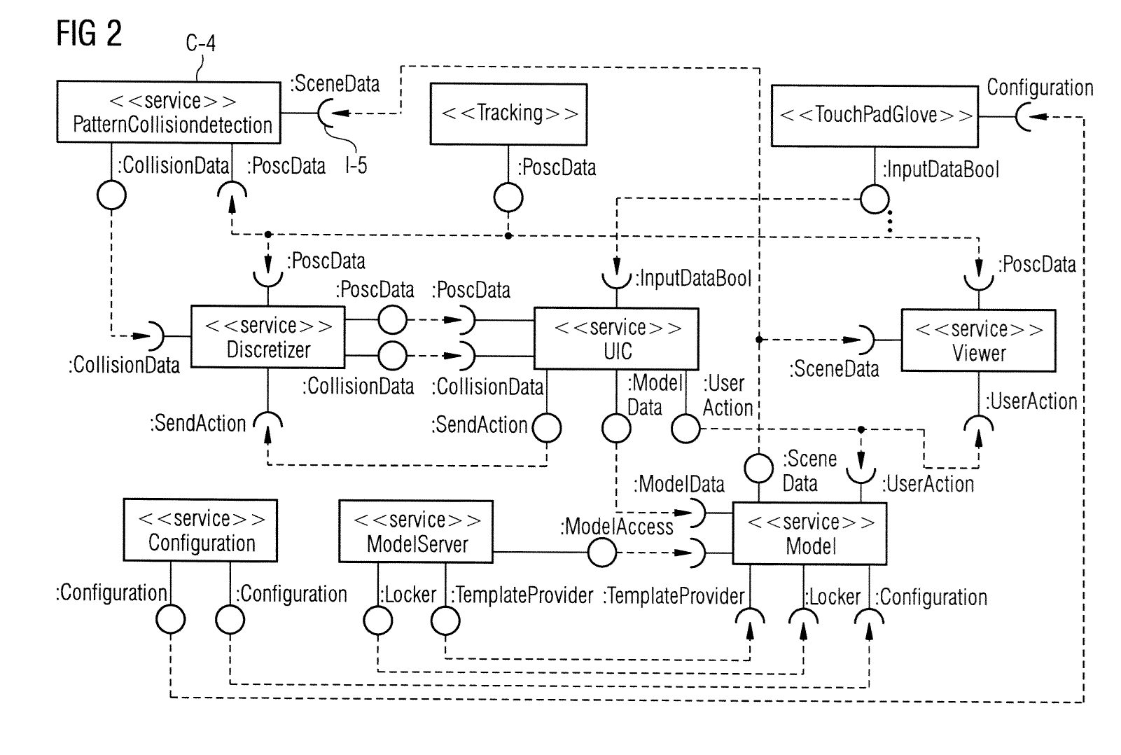

The method according to the embodiment of FIG. 1 starts with identifying S1 interaction markers 3 in data elements 10-1-10-3 of the structured data 4, wherein each interaction marker identifies an interaction interface of the respective data element 10-1-10-3.

In a second step S2 at least one predetermined attribute 6 of the identified interaction markers 3 is analyzed.

The method continues by selecting S3 a symbolic representation 8, 8-1-8-10 for each of the identified interaction markers 3 based on the respective at least one analyzed predetermined attribute 6.

Finally in a fourth step the graphical representation of the structured data 4 is generated using the respective selected symbolic representations 8, 8-1-8-10 for all identified interaction markers 3.

In one embodiment when identifying S1 interaction markers 3 in data elements 10-1-10-3 of the structured data 4, the structured data 4 is a description 4 of a UML class diagram, e.g. a XML-document, and the data elements 10-1-10-3 are classes 10-1-10-3 of the UML class diagram. Likewise, the interaction markers 3 are interface definitions 3 of said classes 10-1-10-3.

Therefore in the second step S2 when analyzing at least one predetermined attribute 6 attributes of the interface definitions 3 are analyzed. These attributes comprise at least one of, but are not limited to, a name of the interface definition 3, a position of the respective interface in an inheritance hierarchy, a number of methods defined in an interface, annotations in the source code of said interface, the visibility of said interface, e.g. private, protected, public or the like, the number of implementations of said interface, the number of uses of said interface, and/or the role of the respective interface in a design pattern. In one embodiment the predetermined attributes can be extracted from a running computer program which is constructed based on the structured data. In such an embodiment the attributes could e.g. comprise the number of calls to an interface or the callers of an interface or the like.

In this embodiment the method continues by automatically selecting S3 a symbolic representation 8, 8-1-8-10 for each of the identified interface definitions 3 based on the analyzed attributes 6.

In one embodiment the selection mechanism comprises selecting similar symbolic representations 8, 8-1-8-10 for interfaces with similar attribute values. For example for all public or private interfaces symbolic representations 8, 8-1-8-10 of the same colour could be selected. Furthermore, symbolic representations 8, 8-1-8-10 could be selected according to an interface's function. E.g. administrative interfaces, or operative interfaces or the like could be illustrated with certain colours, or shapes (e.g. stars), or even pictograms.

Different forms of different symbolic representations 8, 8-1-8-10 comprise, but are not limited to, symbols having a natural order and/or symbols having no natural order, symbols having round corners and/or indented sides and/or outdented sides and/or symbols having a specific horizontal orientation and/or symbols having a specific size and/or aspect ratio and/or shading and/or outline width and/or symbols having a specific animation when displayed on screen. Symbols could also represent letters and/or numbers and/or pictograms.

Finally in the fourth step S4 the graphical representation of the structured data 4 is generated using plug-like symbolic representations 8, 8-1-8-10 in conjunction with classes that implement an interface and provide the functions defined by said interface, and using socket like symbolic representations 8, 8-1-8-10 in conjunction with classes that need another class to implement an interface and use the functions defined by said interface.

In another embodiment the plug-like symbolic representations 8, 8-1-8-10 are used in conjunction with classes that need another class to implement an interface and use the functions defined by said interface, and socket like symbolic representations 8, 8-1-8-10 are used in conjunction with classes that implement an interface and provide the functions defined by said interface.

In one embodiment a legend is added to the class diagram, wherein the legend comprises at least the plug-like or the socket-like symbolic representation 8, 8-1-8-10 for every interface definition 3, and furthermore comprises the name of said interface in conjunction with the respective symbolic representation 8, 8-1-8-10.

FIG. 4 shows a block diagram of an embodiment of a generation apparatus 1 according to an example embodiment.

The apparatus 1 comprises an identification unit 2 configured to identify interaction markers 3 in data elements 10-1-10-3 of the structured data 4.

An analyzing unit 5 analyzes attributes 6 of the identified interaction markers 3 and a selection unit 7 selects a symbolic representation 8, 8-1-8-10 for each of the identified interaction markers 3 based on the respective at least one analyzed predetermined attribute 6.

Finally a generation unit 9 generates the graphical representation of the structured data 4 using the respective selected symbolic representations 8, 8-1-8-10 for all identified interaction markers 3.

In one embodiment the identification unit 2, the analyzing unit 5, the selection unit 7, and the generation unit 9 are embodied as microprocessors. In another embodiment the identification unit 2, the analyzing unit 5, the selection unit 7, and the generation unit 9 are embodied as application specific integrated circuit, as programmable logic device, as field programmable gate array or the like. In yet another embodiment the identification unit 2, the analyzing unit 5, the selection unit 7, and the generation unit 9 are embodied as hardware, firmware, software or any combination thereof.

In yet another embodiment other components can be provided in the apparatus according to an example embodiment. For example in one embodiment a memory is provided to store the symbolic representations 8, 8-1-8-10.

FIG. 5 shows another block diagram of an embodiment of a generation apparatus 1 according to an example embodiment.

The generation apparatus 1 comprises a computation unit 12 comprising a program memory 13. Furthermore, the program memory 13 comprises computer readable instructions which cause the computation unit 12 to execute a method according to an example embodiment.

In one embodiment the computation unit 12 is embodied as microprocessor. In another embodiment the computation unit 12 is embodied as application specific integrated circuit, as programmable logic device, as field programmable gate array or the like. In yet another embodiment the computation unit 12 is embodied as hardware, firmware, software or any combination thereof.

The program memory 13 can be embodied as RAM, ROM, Harddisk unit, or any kind of memory configured to store computer readable instructions.

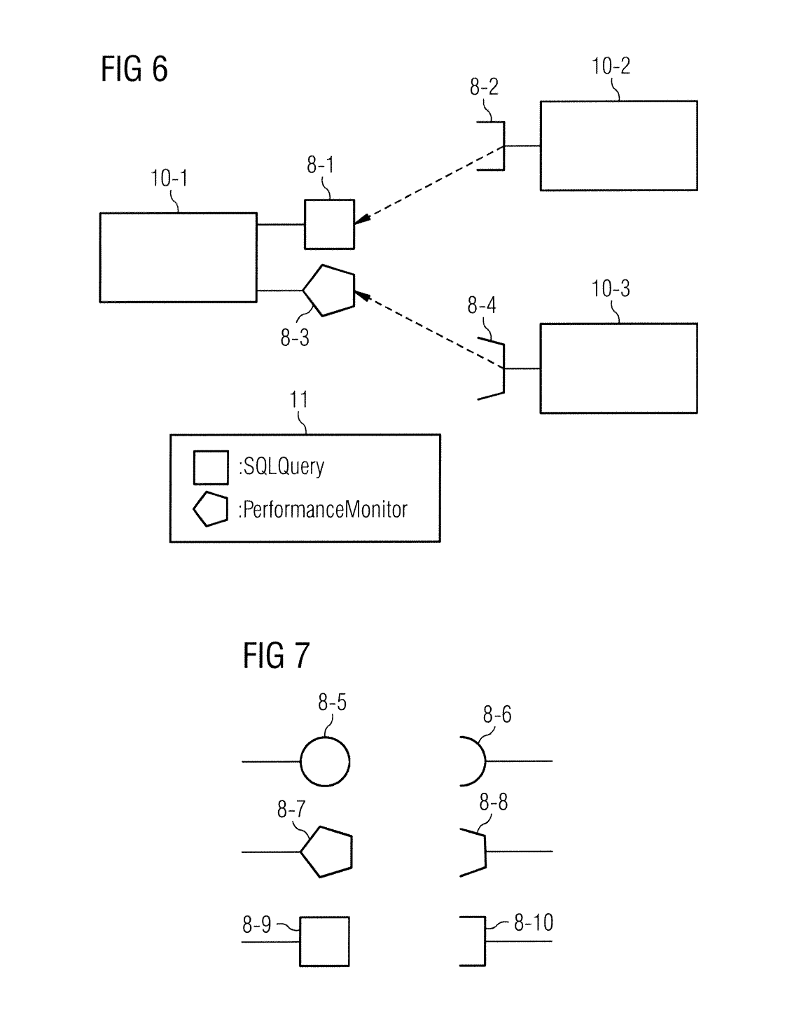

FIG. 6 shows an embodiment of a class diagram according to an example embodiment.

The class diagram in FIG. 6 comprises the data elements 10-1-10-3 embodied as classes 10-1-10-3 of a computer program. Furthermore class 10-1 comprises symbolic representations 8-1, 8-3 of two interfaces. Class 10-2 comprises a symbolic representation 8-2 and class 10-3 comprises a symbolic representation 8-4.

In FIG. 6 the symbolic representation 8-1 is a full square. Symbolic representation 8-2 is half a square that is adapted to embrace the full square 8-1. Furthermore, symbolic representation 8-3 is a full pentagon and symbolic representation 8-4 is half a pentagon adapted to embrace the full pentagon 8-3. In the lower area of FIG. 6 a legend 11 displays the square together with the name of the respective interface, “SQLQuery”, and the pentagon together with the name of the second respective interface, “PerformanceMonitor”.

FIG. 7 shows an embodiment of different graphical representations 8-5-8-10 according to an example embodiment.

In FIG. 7 three different pairs of corresponding symbolic representations 8-5-8-10 are shown.

A first pair of corresponding symbolic representations 8-5-8-6 comprises a circle 8-5 and half a circle 8-6 adapted to embrace the full circle 8-5.

Symbolic representation 8-7 is a full pentagon and symbolic representation 8-8 is half a pentagon adapted to embrace the full pentagon 8-7.

Symbolic representation 8-9 is a full square and symbolic representation 8-10 is half a square that is adapted to embrace the full square 8-9.

Further symbolic representations 8-1-8-10 are also possible. For example symbolic representations 8-1-8-10 could comprise letters, symbols, pictograms, e.g. an arrow and a mark, arrows or the like.

Furthermore, the symbolic representations 8-1-8-10 could be adapted by indenting or outdenting the lines of the symbols or by stretching or changing the orientation of the symbols.

Although specific embodiments have been illustrated and described herein, it will be appreciated by those of ordinary skill in the art that a variety of alternate and/or equivalent implementations exist. It should be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

In the foregoing detailed description, various features are grouped together in one or more example or examples for the purpose of streamlining the disclosure. It is understood that the above description is intended to be illustrative, and not restrictive. It is intended to cover all alternatives, modifications and equivalents as may be included within the scope of the disclosure. Many other examples will be apparent to one skilled in the art upon reviewing the above specification.

Specific nomenclature used in the foregoing specification is used to provide a thorough understanding of the disclosure. However, it will be apparent to one skilled in the art in light of the specification provided herein that the specific details are not required in order to practice certain embodiments. Thus, the foregoing descriptions of specific embodiments are presented for purposes of illustration and description. They are not intended to be exhaustive or to limit the disclosure to the precise forms disclosed; obviously many modifications and variations are possible in view of the above teachings. The embodiments were chosen and described in order to best explain certain principles of the disclosure and its practical applications, to thereby enable others skilled in the art to best utilize the disclosure and various embodiments with various modifications as are suited to the particular use contemplated. Throughout the specification, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on or to establish a certain ranking of importance of their objects.

1. A method for generating a graphical representation of structured data, the method comprising:
identifying interaction markers in data elements of the structured data, wherein each interaction marker identifies an interaction interface of the respective data element;
analyzing at least one predetermined attribute of the identified interaction markers;
selecting a symbolic representation for each of the identified interaction markers based on the respective at least one analyzed predetermined attribute; and
generating the graphical representation of the structured data using the respective selected symbolic representations for all identified interaction markers.

2. The method of claim 1, wherein analyzing at least one predetermined attribute comprises statically analyzing at least one of: the structured data, a documentation of the structured data, and at runtime a computer program which is constructed based on the structured data.

3. The method of claim 1, wherein the structured data comprises a description of a UML data structure.

4. The method of claim 3, wherein the structured data comprises at least one description of a UML class diagram in XML format.

5. The method of claim 4, wherein the interaction markers comprise interface definitions of interfaces in the description of the UML class diagram, wherein the interfaces define at least one function which is implemented by at least one class of the UML class diagram.

6. The method of claim 5, wherein analyzing at least one predetermined attribute of the identified interaction markers comprises analyzing at least one of: a name in an inheritance hierarchy, a position in an inheritance hierarchy, a number of methods, annotations, public status, private status, number of implementations, number of uses, and role in a design pattern of the respective interface.

7. The method of claim 5, wherein selecting a symbolic representation for each of the interaction markers comprises selecting a symbolic representation comprising a plug-like symbolic representation for an interaction marker which is associated with a class that implements at least one interface.

8. The method of claim 5, wherein selecting a symbolic representation for each of the interaction markers comprises selecting a symbolic representation comprising a socket-like symbol for an interaction marker which is associated with a class that uses functions provided by at least one interface.

9. The method of claim 1, wherein selecting a symbolic representation for each of the interaction markers comprises selecting a stored symbolic representation comprising at least one of: symbols having a natural order, symbols having no natural order, a regular polygon, and a star with at least three spikes.

10. The method of claim 1, wherein selecting a symbolic representation for each of the interaction markers comprises selecting a stored symbolic representation comprising at least one of: symbols having round corners, symbols having indented sides, symbols having outdented sides, symbols having a specific horizontal orientation, symbols having a specific color, symbols having a specific size, symbols having a specific aspect ratio, symbols having a specific shading, symbols having a specific outline width, and symbols having a specific animation when displayed on screen.

11. The method of claim 1, wherein selecting a symbolic representation for each of the interaction markers comprises selecting a stored symbolic representation comprising symbols representative of at least of: letters and numbers.

12. The method of claim 1, wherein selecting a symbolic representation for each of the interaction markers comprises selecting a stored symbolic representation comprising pictograms.

13. A generation apparatus for generating a graphical representation of structured data, the apparatus comprising:
an identification unit configured to identify interaction markers in data elements of the structured data, wherein each interaction marker identifies an interaction interface of the respective data element;
an analyzing unit configured to analyze at least one predetermined attribute of the identified interaction markers;
a selection unit configured to select a symbolic representation for each of the identified interaction markers based on the respective at least one analyzed predetermined attribute; and
a generation unit configured to generate the graphical representation of the structured data using the respective selected symbolic representations for all identified interaction markers.

14. The generation apparatus of claim 13, wherein the analyzing unit is configured to analyze at least one of: the structured data, a documentation of the structured data, and at runtime a computer program which is constructed based on the structured data.

15. The generation apparatus of claim 13, wherein the structured data comprises at least one description of a UML class diagram in XML format.

16. The generation apparatus of claim 15, wherein the interaction markers comprise interface definitions of interfaces in the description of the UML class diagram, wherein the interfaces define at least one function which is implemented by at least one class of the UML class diagram.

17. The generation apparatus of claim 15, wherein the analyzing unit is configured to analyze at least one of: a name in an inheritance hierarchy, a position in an inheritance hierarchy, a number of methods, annotations, public status, private status, number of implementations, number of uses, and role in a design pattern of the respective interface.

18. The generation apparatus of claim 15, wherein the selection unit is configured to select a symbolic representation comprising a plug-like symbolic representation for an interaction marker which is associated with a class that implements at least one interface; and
wherein the selection unit is configured to select a symbolic representation comprising a socket-like symbol for an interaction marker which is associated with a class that uses functions provided by at least one interface.

19. The generation apparatus of claim 13, wherein the selection unit is configured to select a stored symbolic representation comprising at least one of: symbols having a natural order, symbols having no natural order, a regular polygon, and a star with at least three spikes.

20. The generation apparatus of claim 13, wherein the selection unit is configured to select a stored symbolic representation comprising at least one of: symbols having round corners, symbols having indented sides, symbols having outdented sides, symbols having a specific horizontal orientation, symbols having a specific color, symbols having a specific size, symbols having a specific aspect ratio, symbols having a specific shading, symbols having a specific outline width, and symbols having a specific animation when displayed on screen.

21. The generation apparatus of claim 13, wherein the selection unit is configured to select a stored symbolic representation comprising symbols representative of letters or numbers; and
wherein the selection unit is configured to select a stored symbolic representation comprising pictograms.

22. A generation apparatus for generating a graphical representation of structured data, the apparatus comprising:
a computation unit comprising a program memory, the program memory comprising computer readable instructions which cause the computation unit to:
identify interaction markers in data elements of the structured data, wherein each interaction marker identifies an interaction interface of the respective data element;
analyze at least one predetermined attribute of the identified interaction markers;
select a symbolic representation for each of the identified interaction markers based on the respective at least one analyzed predetermined attribute; and
generate the graphical representation of the structured data using the respective selected symbolic representations for all identified interaction markers.

23. A computer program product for generating a graphical representation of structured data, the computer program product comprising computer readable instructions for:
identifying interaction markers in data elements of the structured data, wherein each interaction marker identifies an interaction interface of the respective data element;
analyzing at least one predetermined attribute of the identified interaction markers;
selecting a symbolic representation for each of the identified interaction markers based on the respective at least one analyzed predetermined attribute; and
generating the graphical representation of the structured data using the respective selected symbolic representations for all identified interaction markers.
